(19) United States
(12) Patent Application Publication
(10) Pub. No.: US 2021/0368783 A1
(43) Pub. Date: Dec. 2, 2021

(54) Herbicide Formulation

(71) Applicant: ADAMA AUSTRALIA PTY LIMITED, New South Wales (AU)

(72) Inventor: George GLOWKA, New South Wales (AU)

(21) Appl. No.: 16/980,603

(22) PCT Filed: Mar. 12, 2019
(86) PCT No.: PCT/AU2019/000036

§ 371 Date: Sep. 14, 2020

(30) Foreign Application Priority Data
Mar. 13, 2018 (AU) 2018201794

(51) Int. Cl. A01N 25/02; A01N 25/30; A01N 39/04; A01N 33/04; A01P 13/00

(52) U.S. Cl. CPC A01N 25/02; A01N 25/30; A01P 13/00; A01N 33/04; A01N 39/04

(57) ABSTRACT

The invention provides a soluble liquid herbicide formulation comprising 2, 4-D, in the form of two amine salts, an effective amount of an alkoxylate surfactant and an effective amount of ethylene glycol. The formulations of the invention are crystallisation tolerant at low temperatures.

### TECHNICAL FIELD

The invention relates to a herbicide formulation. In particular, the invention is directed to a herbicide formulation containing salts of 2,4-dichlorophenoxyacetic acid (2,4-D).

### BACKGROUND ART

The herbicide 2,4-D has been known as a systemic selective herbicide for weeds, especially broad-leaf weeds, since the 1940s. This herbicide has been used in a wide range of formulations to control weeds, especially in grasses and cereal crops, but also in non-crop situations.

More recently, 2,4-D formulations have been in use, usually as liquids, in which the active ingredient is high—over about 70% w/v. However, when exposed to low temperatures approaching zero Celsius, such highly loaded formulations can become partially or entirely crystallised. Crystallisation is undesirable. It can reduce the effectiveness of the herbicide. It can result in clogging of spray equipment.

It is therefore an aim of the invention to provide a liquid 2,4-D herbicide formulation at a relatively high concentration which is crystallisation tolerant at low temperatures.

### SUMMARY OF THE INVENTION

Accordingly, the invention provides a liquid herbicide formulation comprising:
2,4-D in the form of two only alkylamine salts, being
   isopropyl amine and dimethylamine; or
   diethylamine and dimethylamine;
an alkoxylate surfactant, and
ethylene glycol,

wherein the formulation includes at least 600 g/L of 2,4-D; and

wherein the quantities of the alkylamine salts, the alkoxylate surfactant and ethylene glycol are such that the formulation resists crystallisation at a temperature of about minus 4° C. to 0° C.

Preferably, the alkoxylate surfactant is an ethoxylated fatty amine or a copolymer alkoxylate. The ethoxylated fatty amine is preferably ethoxylated tallow amine, such as available under the trademark Terwet 3780. An example of an effective amount is about 20 g/L. It is preferred that the ethoxylated fatty amine, if present, does not exceed about 40 g/L.

The copolymer ethoxylate is preferably that available under the trademark Teric BL-8. An example of an effective amount is about 20 g/L.

In both cases, higher or lower amounts of the alkoxylate surfactant may be effective, as will be apparent to a person skilled in the art.

Other surfactants may also be suitable.

Optionally, the formulation may also contain an effective amount of an anti-foaming agent, such as Antifoam A, up to about 1%.

Preferably, the formulation is provided as a soluble liquid (SL).

The formulation is highly loaded with active ingredient, having at least 600 g/L of 2,4-D. In preferred embodiments, the formulation has about 700 g/L, and especially 720 g/L of 2, 4-D.

It is also preferred that the formulation has between 40 and 60 g/L of isopropyl amine (70%). The more preferred quantity is about 45 g/L.

The formulation may have up to about 250 g/L of dimethylamine, more preferably between 100 and 150 g/L of dimethylamine.

The formulation may include from 80 to 100 g/L of diethylamine.

The formulation preferably contains from 20 g/L to 50 g/L of ethylene glycol.

The formulation may have a density of 1.234 g/cm³ at 20° C. In addition, the formulation may have a pH of 9.4 at 20° C.

The molar ratio of the amine salts to 2,4-D is preferably within the range 0.9 to 1.2.

It has been found that the formulation of the invention can advantageously inhibit crystallisation in zero to sub-zero temperatures.

The formulation may inhibit crystallisation when the temperature is about 0° C. Moreover, the formulation may inhibit crystallisation when the temperature is about −2° C. to 0° C. Furthermore, the formulation may inhibit crystallisation when the temperature is about −4 to 0° C.

As illustrated by the examples below and the comparisons in FIG. 1, the formulation details being in FIG. 2, crystallisation may be inhibited when the formulation combines isopropyl amine with dimethylamine or when diethylamine is combined with dimethylamine. When isopropyl amine is present, it is preferably more than about 4% of the formulation.

In order that the invention may be more readily understood and put into practice, one or more preferred embodiments thereof will now be described.

### DETAILED DESCRIPTION OF PREFERRED EMBODIMENTS

The composition of the herbicide formation according to one embodiment of the invention is shown in Example 1 below.

### Example 1: Herbicide Formulation (SL)

| Ingredients | % W/V |
|---|---|
| 2,4-D (99%) | 72.72 |
| Isopropyl amine (95%) | 4.50 |
| Dimethylamine (60%) | 20.20 |
| Terwet 3780 (ethoxylated tallow | 2.00 |
| amine, CAS No. 61791-26-2). | |
| ethylene glycol | 2.00 |
| Water | Up to volume |

The composition of the herbicide formation according to a second embodiment of the invention is shown in Example 2 below.

### Example 2: Herbicide Formulation (SL)

| Ingredients | % W/V |
|---|---|
| 2,4-D (99%) | 72.72 |
| Isopropyl amine (95%) | 5.95 |
| Dimethylamine (60%) | 20.00 |
| Teric BL-8 | 2.00 |
| ethylene glycol | 5.00 |
| Water | Up to volume |

The composition of the herbicide formation according to another embodiment of the invention is shown in Example 3 below.

### Example 3: Herbicide Formulation (SL)

| Ingredients | % W/V |
|---|---|
| 2,4-D (99%) | 72.72 |
| Diethylamine | 10.40 |
| Dimethylamine (60%) | 17.40 |
| Teric BL-8 | 2.00 |
| ethylene glycol | 5.00 |
| Water | Up to volume |

Efficacy and Safety Studies

Tests were carried out to determine the properties and performance of the herbicide formulation of Example 1, when compared to those of other known herbicide formulations.

The herbicide products used in the studies are listed in Table 1 below.

TABLE 1
Herbicide products used in trials

| Product/trade | Active | Concentration | |
|---|---|---|---|
| name | ingredient (ai) | of ai | Formulation |
| Example 1 | 2,4-D amine | 720 g/L | Soluble liquid |
| Zulu evo 720 | 2,4-D amine | 720 g/L | Soluble liquid |
| Wipe-Out 450 | Glyphosate | 450 g/L | Soluble liquid |
| Amicide | 2,4-D amine | 700 g/L | Soluble concentrate |
| Advance 700 | | | |

The following six field trial studies were conducted to compare the efficacy and/or crop safety of the Example 1 formulation compared to ZULU evo 720 and Amicide Advance 700. The purpose was to establish whether the Example 1 formulation was bioequivalent with Zulu evo 720 and Amicide Advance 700 in efficacy and safety. The efficacy and safety of Zulu evo 720 was compared with that of Amicide Advance 700. Specific efficacy and/or crop safety tests were carried out to establish bioequivalence of the Example 1 formulation with Zulu evo 720.
1. Trial: Evaluation for the control of fat hen (Chenopodium album), sow thistle (Sonchus oleraceus) and apple of peru (Nicandra physalodes) in winter fallow, to compare the efficacy of the Example 1 formulation and Zulu evo 720, with and without the addition of Wipe-Out 450. A small plot herbicide trial was conducted in winter fallow conducted in Gatton, Queensland.
   One application of the treatments, in a spray volume of 100 L/ha was made when the weeds were at an average weed growth stage of BBCH 12-18. Weed control assessments were conducted at 7, 14, 22, 33 and 42 days after application. A weed density assessment was conducted prior to application and at 42 days after application.
   All rates of Example 1 formulation and Zulu evo 720 gave significant control of fat hen, sow thistle and apple of Peru compared to the untreated control. The efficacy assessments demonstrated that the Example 1 formulation was equivalent to Zulu evo 720 for the control of fat hen, sow thistle and apple of Peru when applied at equivalent rates of active ingredient.
2. Trial: Evaluation of efficacy and crop safety of the Example 1 formulation and Zulu evo 720 at equivalent rates of 540, 1080 or 2160 g ai/ha for the control of cobbler's peg (Bidens pilosa) and common sida (Sida rhombifolia) in sugarcane cv. Q208. The trial was conducted in Bundaberg, Queensland.
   A single broadcast application of the treatments, in a spray volume of 200 L/ha was made to 4 leaf ratoon cane with an established population of cobbler's peg and common sida. Weed density assessments were conducted prior to application and 28 days after application. Weed control and crop safety assessments were conducted at 7, 14 and 28 days after application respectively.
   The Example 1 formulation and Zulu evo 720 were equally efficacious in the control of cobbler's peg and common sida when applied at equivalent rates of active ingredient. No symptoms of crop phytotoxicity were recorded at any assessment, and the Example 1 formulation was deemed safe to sugarcane cv. Q208.
3. Trial: Evaluation for the control of common sowthistle (Sonchus oleraceus), flaxleaf fleabane (Conyza bonariensis), turnip weed (Rapistrum rugosum) in winter fallow, to compare the efficacy of the Example 1 formulation and Zulu evo 720, with and without the addition of Wipe-Out 450. The trial was conducted in Dalby, Queensland.
   One application of the treatments, in a spray volume of 85 L/ha, was made when the weeds were at the early post-emergence stage of weed growth. Weed control assessments were conducted at 7, 14, 28 and 43 days after application. A weed density assessment was conducted prior to application and at 43 days after application. Assessments of weed control from this trial confirm that the Example 1 formulation has equivalent efficacy to Zulu evo 720 for the control of turnip weed, common sowthistle and flaxleaf fleabane when used at equivalent rates of active ingredient.
4. Trial: Evaluation for the control of broadleaf weeds including ball mustard (Neslia paniculata), bedstraw (Galium sp.), common vetch (Vicia sativa), and prickly lettuce (Lactuca serriola) in barley cv. Commander, to compare the efficacy of the Example 1 formulation and Zulu evo 720. The trial was conducted in Saddleworth, South Australia.
   One application of the treatments, in a spray volume of 100 L/ha, was made at crop growth stage growth stage. Weed control and crop safety assessments were conducted at 10, 20, 32 and 40 days after application. A weed density assessment was conducted prior to application and at 39 days after application.
   All rates of the Example 1 formulation and Zulu evo 720 gave significant control of bedstraw, ball mustard, common vetch and prickly lettuce compared to the untreated control. The efficacy assessments demonstrated that the Example 1 formulation was equivalent to Zulu evo 720 for the control of bedstraw, ball mustard, common vetch and prickly lettuce when applied at equivalent rates of active ingredient. The Example 1 formulation was deemed safe to barley cv. Commander.
5. Trial: Evaluation to compare Zulu evo 720 and Amicide Advance 700 in combination with Wipe-Out 450 for improving knockdown and control of grass and broadleaf weeds, including caltrop (Tribulus terrestris), common storksbill (Erodium cicutarium), marshmallow (Malva parviflora), pigweed (Portulaca oleracea), and windmill grass (Chloris truncata), in pre-plant fallow situations. The trial was conducted in Shepparton, Victoria.
   One application of the treatments, in a spray volume of 94.6 L/ha, was made to actively growing weeds in fallow. Weed control assessments were conducted at 7, 14, 28 and 47 days after treatment. These included pre-spray weed counts, final weed counts, detailed weed control and regrowth assessments.
   All rates of Zulu evo 20 and Amicide Advance 700 when added to Wipe-Out 450 increased the rate of knockdown of storksbill, marshmallow, caltrop, pigweed and windmill grass, compare to Wipe-Out 450 alone.
   Significant rate responses were also seen in the rate of knockdown at the 7 and 14 days assessment. In general, there was an increasing trend in the rate of knockdown with increasing rates of both Zulu evo 720 and Amicide Advance 700.
   Zulu evo 720 generally provided significantly better knockdown than Amicide Advance 700 when added to Wipe-Out 450 at 198 and 396 g ai/ha.
   The efficacy assessments demonstrated that Zulu evo 720 was equivalent or superior to Amicide Advance 700 for knockdown of storksbill, marshmallow, caltrop, pigweed and windmill grass when applied at equivalent rates of active ingredient.
6. Trial: Evaluation to compare Zulu evo 720 and Amicide Advance 700 in combination with Wipe-Out 450 for improving knockdown and control of grass and broadleaf weeds in a fallow situation. The trial was conducted in Shepparton, Victoria.
   Weeds evaluated in this trial were capeweed (Arctotheca calendula), common chickweed (Stellaria media), fumitory (Fumaria muralis), marshmallow (Malva parviflora), mouse-ear chickweed (Cerastium glomeratum), rough poppy (Papaver hybridum), and wild oats (Avena fatua).
   One application of the treatments, in a spray volume of 92.4 L/ha, was made to actively growing weeds in fallow. Weed control assessments were conducted at 8, 13, 21, 29 and 44 days after treatment. These included pre-spray weed counts, final weed counts, detailed weed control and regrowth assessments. All rates of Zulu evo 720 and Amicide Advance 700 when added to Wipe-Out 450 increased the rate of knockdown of capeweed, chickweed, fumitory, marshmallow, mouse-ear chickweed and rough poppy compared to Wipe-Out 450 alone. All treatments in the trial provided significant knockdown and control of wild oats throughout the assessment period, however no significant differences between the treatments were seen in the rate of knockdown or final level of wild oat control.
   Significant rate responses were also seen for most target weed species at the 8 and 13 days assessments. In general, there was an increasing trend in the rate of knockdown with increasing rates of both Zulu evo 720 and Amicide Advance 700.
   Zulu evo 720 provided equivalent or better knockdown than Amicide Advance 700 when added to Wipe-Out 450 at 198-360 g ai/ha.
   The efficacy assessments demonstrated that Zulu evo 720 was equivalent or superior to Amicide Advance 700 for knockdown of capeweed, chickweed, fumitory, marshmallow, mouse-ear chickweed and rough poppy when applied at equivalent rates of active ingredient.

The results of the trials demonstrated that the Example 1 formulation is bioequivalent to ZULU evo 720, and when applied as directed will provide good control in the situations intended.

The data presented also demonstrated that ZULU evo 720 is equivalent and/or superior to Amicide Advance 700. With equivalence of the Example 1 formulation and Zulu evo 720 established, bioequivalence of the Example 1 formulation with Amicide Advance 700 is also confirmed.

The Example 1 formulation's use pattern is derived from both the ZULU evo 720 and Amicide Advance 700 labels. Comparison of labels for all three products confirmed a significant proportion of analogous use patterns; therefore broader equivalence of the Example 1 formulation with Amicide Advance 700 could be expected.

Crystallisation Tests

The liquid formulations were tested at 0±2° C. or lower for more than seven days. The effect of low temperatures on stability were determined and reported according to Collaborative International Pesticide Analytical Council (CIPAC) method MT 39.3 (liquid formulations).

The formulations in Examples 1, 2 and 3 were tested with comparison formulations not falling within the scope of the invention. As indicated in each of Tables 2, 3 and 4 which follow the description below, the formulations in Examples 1, 2 and 3 are identified as AR-40B, AR-51C and AR-52B respectively.

Table 2 shows results for 2, 4-D 720 crystallisation testing at low temperatures. Out of the trials, the three formulations in Examples 1, 2 and 3 inhibited crystallisation of 2,4-D in water at concentration 720 g/L.

The details of the three formulations are shown in Table 3. It was noted that the combination of amines, proportions between them and ethylene glycol presence in the formulations played a main role in inhibition of crystallisation. Replacement of ethoxylated fatty amine by polyalkylene oxide derivative of a synthetic alcohol in the same quantity (Teric BL8) did not significantly reduce inhibition of crystallisation in the formulations of Examples 2 and 3.

The molar ratios of amines to 2,4-D in each of the formulations in Examples 1, 2 and 3, respectively were determined. The detailed results are shown in Table 4. The molar ratio for the Example 1 formulation was 0.988. The molar ratio for the Example 2 formulation was 1.035, while the molar ratio for the Example 3 formulation was 1.148.

The foregoing embodiments are intended to be illustrative of the invention, without limiting the scope thereof. The invention is capable of being practised with various modifications and additions as will readily occur to those skilled in the art.

Accordingly, it is to be understood that the scope of the invention is not to be limited to the exact construction and operation described and illustrated, but only by the following claims which are intended to include all suitable modifications and equivalents permitted by the applicable law.

The term “comprise” and variants of that term such as “comprises” or “comprising” are used herein to denote the inclusion of a stated integer or integers but not to exclude any other integer or any other integers, unless in the context or usage an exclusive interpretation of the term is required.

Reference to prior art disclosures in this specification is not an admission that the disclosures constitute common general knowledge.

TABLE 2
2,4-D 720 samples in crystallisation test: Target temp: 0° C. to +
or − 2° C. (temperature record started on 17 December)

| | Temp: | | | | | | | |
|---|---|---|---|---|---|---|---|---|
| | in bottle/ | Dow | | | | | | |
| Check | in air/in | Sample | Nufarm | | AR-40B | | | |
| Date | air ° c.*) | 2A2297110 | 137591-0052 | AR-40A | (Example 1) | AR-41 | AR-51A | AR-51B |
| 8 Dec | | Clear | Clear | Clear | Clear | Clear | Clear | Clear |
| 9 Dec | | Clear | Clear | Clear | Clear | Clear | Clear | Clear |
| 10 Dec | | Clear | Clear | Clear | Clear | (d) Solid | (d) Solid | (d) Solid |
| 11 Dec | | Clear | Clear | Clear | Clear | (d) Solid | (d) Solid | (d) Solid |
| 12 Dec | | Clear | Clear | Clear | Clear | (d) Solid | (d) Solid | (d) Solid |
| 15 Dec | | Clear | (b) Solid | Clear | Clear | (d) Solid | (d) Solid | (d) Solid |
| 16 Dec | | Clear | (c) Solid | Clear | Clear | (d) Solid | (d) Solid | (d) Solid |
| | | (crystal | | (one small | (crystal | | | |
| | | was added | | crystal | was added | | | |
| | | on 16/12) | | observed) | on 16/12) | | | |
| 17 Dec | all minus | Clear | (c) Solid | (d) Solid | Clear | (d) Solid | (d) Solid | (d) Solid |
| | 2/4.5/4.63 | | | | | | | |
| 18 Dec | all minus | Clear | (c) Solid | (d) Solid | Clear | (d) Solid | (d) Solid | (d) Solid |
| | 1.5/4.0/4.2 | | | | | | | |
| 19 Dec | all minus | Clear | (c) Solid | (d) Solid | Clear | (d) Solid | (d) Solid | (d) Solid |
| | 2.0/3.5/3.8 | | | | | | | |
| 22 Dec | all minus | Clear | (c) Solid | (d) Solid | Clear | (d) Solid | (d) Solid | (d) Solid |
| | 3.0/3.5/3.6 | | | | | | | |
| 23 Dec | all minus | Clear | (c) Solid | (d) Solid | Clear | (d) Solid | (d) Solid | (d) Solid |
| | 3.0/3.5/NA | | | | | | | |

Christmas break - no temperature record

| | | | | | | | | |
|---|---|---|---|---|---|---|---|---|
| 5 Jan | all minus | (c) Solid | (c) Solid | (d) Solid | Clear | (d) Solid | (d) Solid | (d) Solid |
| | 3.0/NA | | | | | | | |

| | | | | | | Note: |
|---|---|---|---|---|---|---|
| Check | AR-51C | | AR-52B | | | Initial Samples |
| Date | (Example 2) | AR-52A | (Example 3) | AR-52C | AR-08A | no seeded |
| 8 Dec | Clear | Clear | Clear | Clear | | |
| 9 Dec | Clear | Clear | Clear | Clear | | Crystal |
| | | | | | | seeds added |
| 10 Dec | Clear | (d) Solid | Clear | Clear | | |
| 11 Dec | Clear | (d) Solid | Clear | Clear | | |
| 12 Dec | Clear | (d) Solid | Clear | Clear | | |
| 15 Dec | Clear | (d) Solid | Clear | (d) Solid | Clear | AR-08A |
| | | | | | | sample in |
| 16 Dec | Clear | (d) Solid | Clear | (d) Solid | Clear | Crystals |
| | (crystal | | (crystal | | (crystal | seeds added |
| | was added | | was added | | was added | to the |
| | on 16/12) | | on 16/12) | | on 16/12. | samples |
| | | | | | After 30 | which |
| | | | | | min of | do not |
| | | | | | crystal seed | crystallise |
| | | | | | addition | |
| | | | | | product | |
| | | | | | starts to | |
| | | | | | crystallise | |
| 17 Dec | Clear | (d) Solid | Clear | (d) Solid | (d) Solid | |
| 18 Dec | Clear | (d) Solid | Clear | (d) Solid | (d) Solid | |
| 19 Dec | Clear | (d) Solid | Clear | (d) Solid | (d) Solid | |
| 22 Dec | Clear | (d) Solid | Clear | (d) Solid | (d) Solid | |
| 23 Dec | Clear | (d) Solid | Clear | (d) Solid | (d) Solid | |
| Christmas break - no temperature record | | | | | | |
| 5 Jan | Clear | (d) Solid | Clear | (d) Solid | (d) Solid | NO |
| | | | | | | additional |
| | | | | | | crystals |
| | | | | | | were added |

Degree of crystallisation:
(a) No crystals
(b) Small quantity of crystals (approx. 1 mm layer)
(c) High level of crystallisation
(d) Whole volume of sample has solidified
*)First temperature is temperature in liquid in fridge with glass thermometer
Second temperature is temperature of air in fridge recorded by thermometer
Third temperature is temperature of air in fridge recorded by Data lodger

TABLE 3
Record of 2,4-D 720 Trial Details

| | Trial No.: | | | | | | | | | |
|---|---|---|---|---|---|---|---|---|---|---|
| | | AR-40B | | | | AR-51C | | AR-52B | | |
| | AR-40A | (Example 1) | AR-41 | AR-51A | AR-51B | (Example 2) | AR-52A | (Example 3) | AR-52C | AR-08A |
| Ingredients | % W/V | % W/V | % W/V | % W/V | % W/V | % W/V | % W/V | % W/V | % W/V | % W/V |
| 2,4D (99%) | 72.72 | 72.72 | 72.72 | 72.72 | 72.72 | 72.72 | 72.72 | 72.72 | 72.72 | 72.72 |
| Isopropyl amine (95%) | 4.5 | 4.50 | N/A | N/A | 2.95 | 5.95 | N/A | N/A | N/A | 5.8 |
| Diethylamine | N/A | N/A | N/A | N/A | N/A | N/A | N/A | 10.40 | N/A | N/A |
| Dimethylamine (60%) | 19.1 | 20.20 | 26 | 27.0 | 25.0 | 20.00 | 16.0 | 17.40 | 18.4 | 21.1 |
| Terwet 3780 | 5.0 | 2.00 | 5.0 | N/A | N/A | N/A | N/A | N/A | N/A | N/A |
| Teric BL-8 | N/A | N/A | N/A | 2.0 | 2.0 | 2.00 | 2.0 | 2.00 | 2.0 | 2.0 |
| Ethylene Glycol | 2.0 | 2.00 | 2.0 | 5.0 | 5.0 | 5.00 | 5.0 | 5.00 | 5.0 | N/A |
| Antifoam A | 0.1 | N/A | N/A | 0.05 | 0.05 | 0.05 | 0.05 | 0.05 | 0.05 | N/A |
| NMP | 2.0 | N/A | N/A | N/A | N/A | N/A | N/A | N/A | N/A | N/A |
| TEA | N/A | N/A | N/A | N/A | N/A | N/A | 10.0 | N/A | N/A | N/A |
| Butyl Amine | N/A | N/A | N/A | N/A | N/A | N/A | N/A | N/A | 10.0 | N/A |
| Water | 18.08 | 21.38 | 17.48 | 16.43 | 15.03 | 17.18 | 15.73 | 14.68 | 14.07 | 21.08 |

TABLE 4
2,4-D 720 Trials Details
Molar ratio of amines in formulas AR-40B, AR-51C, AR-52B
All molar ratios are calculated as total quantity of moles of both amines against 2,4D quantity of moles

| | Trial No | | | | | | | | | |
|---|---|---|---|---|---|---|---|---|---|---|
| | | AR-40B | | | AR-51C | | | AR-52B | | |
| | | (Example 1) | No of | Molar | (Example 2) | No of | Molar | (Example 3) | No of | Molar |
| Ingredients | Mol wt | % W/V | Moles | Ratio | % W/V | Moles | Ratio | % W/V | Moles | Ratio |
| 2,4-D (99%) | 221.04 | 72.72 | 0.325 | 1.000 | 72.72 | 0.325 | 1.000 | 72.72 | 0.325 | 1.000 |
| Isopropyl amine (70%) | 59.11 | 4.50 | 0.053 | 0.164 | 5.95 | 0.070 | 0.217 | N/A | | |
| Diethyl amine (99%) | 73.14 | N/A | | | N/A | | | 10.40 | 0.142 | 0.437 |
| Dimethyl amine (60%) | 45.08 | 20.20 | 0.268 | 0.825 | 20.00 | 0.266 | 0.818 | 17.40 | 0.231 | 0.711 |
| Terwet 3780 | | 2.00 | | | N/A | | | N/A | | |
| Teric BL-8 | | N/A | | | 2.00 | | | 2.00 | | |
| Ethyleneglycol | | 2.00 | | | 5.00 | | | 5.00 | | |
| Anfifoam A | | N/A | | | 0.05 | | | 0.05 | | |
| Water | | Up to | | | Up to | | | Up to | | |
| | | volume | | | volume | | | volume | | |

| | | | |
|---|---|---|---|
| Moles of amines/2,4-D ratio | 0.968 | 1.035 | 1.148 |

| | | | |
|---|---|---|---|
| Surplus of both amines quantity above 2,4D quantity | 12% less | 3.50% | 14.80% |
| (as % of amine moles above 2,4D quantity of moles. | | | |

1. A liquid herbicide formulation comprising:
2,4-D in the form of two only alkylamine salts, being
isopropyl amine and dimethylamine; or
diethylamine and dimethylamine;
an alkoxylate surfactant, and
ethylene glycol,
wherein the formulation includes at least 600 g/L of 2,4-D; and
wherein the quantities of the alkylamine salts, the alkoxylate surfactant and ethylene glycol are such that the formulation resists crystallisation at a temperature of about minus 4° C. to 0° C.

2. The herbicide formulation of claim 1 which also contains an effective amount of an anti-foaming agent.

3. The herbicide formulation of claim 1 or 24, wherein the formulation includes about 720 g/L of 2,4-D.

4. The herbicide formulation according to any one of the preceding claims, wherein the formulation includes from 40 g/L to 60 g/L of isopropyl amine and from 100 to 150 g/L of dimethylamine.

5. The herbicide formulation according to any one of claims 1 to 4, wherein the formulation includes from 80 to 100 g/L of diethylamine and from 100 to 150 g/L of dimethylamine.

6. The herbicide formulation according to any one of the preceding claims, wherein the alkoxylate surfactant is ethoxylated tallow amine or a copolymer alkoxylate.

7. The herbicide formulation according to any one of the preceding claims, wherein the alkoxylate surfactant is Terwet 3780 or Teric BL-8 in an amount of about 20 g/L.

8. The herbicide formulation according to any one of the preceding claims, wherein the formulation includes from 20 to 50 g/L of ethylene glycol.

9. The herbicide formulation of any of the preceding claims, wherein the molar ratio of the alkylamines to 2,4-D is within the range 0.9 to 1.2.

10. The herbicide formulation according to any one of the preceding claims, wherein the formulation is a soluble liquid.

11. A liquid herbicide formulation comprising:
at least 600 g/L of 2,4-D,
isopropyl amine and dimethylamine,
an alkoxylate surfactant, and
ethylene glycol;
wherein the quantities of isopropyl amine, dimethylamine, the alkoxylate surfactant and ethylene glycol are such that the formulation resists crystallisation at a temperature of about minus −4° C. to 0° C.

12. A liquid herbicide formulation comprising:
at least 600 g/L of 2,4-D,
isopropyl amine and dimethylamine.
an alkoxylate surfactant,
ethylene glycol, and
an antifoaming agent;
wherein the quantities of isopropyl amine, dimethylamine, the alkoxylate surfactant and ethylene glycol are such that the formulation resists crystallisation at a temperature of about minus −4° C. to 0° C.

13. A liquid herbicide formulation comprising:
at least 600 g/L of 2,4-D,
diethylamine and dimethylamine.
an alkoxylate surfactant,
ethylene glycol, and an antifoaming agent;
wherein the quantities of diethylamine, dimethylamine, the alkoxylate surfactant and ethylene glycol are such that the formulation resists crystallisation at a temperature of about minus −4° C. to 0° C.

14. A liquid herbicide formulation comprising:
about 720 g/L of 2,4-D,
about 40 to 50 g/L of isopropyl amine;
about 110 to 120 g/L of dimethylamine,
about 20 g/L of an alkoxylate surfactant, and
about 20 g/L of ethylene glycol.

15. A liquid herbicide formulation comprising:
about 720 g/L of 2,4-D,
about 50 to 60 g/L of isopropyl amine;
about 120 g/L of dimethylamine,
about 20 g/L of an alkoxylate surfactant, and
about 50 g/L of ethylene glycol.

16. A liquid herbicide formulation comprising:
about 720 g/L of 2,4-D,
about 100 to 110 g/L of diethylamine;
about 1700 to 1810 g/L of dimethylamine,
about 20 g/L of an alkoxylate surfactant, and
about 50 g/L of ethylene glycol.
